(19) United States
(12) Patent Application Publication
(10) Pub. No.: US 2009/0016678 A1
(43) Pub. Date: Jan. 15, 2009

(54) OPTICAL MODULE

(75) Inventors: Atsushi KAWAMURA, Tokyo (JP); Tatsuo HATTA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/166,639

(22) Filed: Jul. 2, 2008

(30) Foreign Application Priority Data
Jul. 12, 2007 (JP) 2007-183554

(51) Int. Cl. G02B 6/32

(52) U.S. Cl. 385/33

(57) ABSTRACT

An optical module includes an optical waveguide member for passing light therethrough and an optical path changing member for receiving and reflecting light. The optical path changing member is optically coupled to the optical waveguide member.

The optical module further includes a lens optically coupled to the optical path changing member. The optical module further includes a first optical device and a second optical device. The first optical device and the second optical device are disposed to face the optical path changing member through the lens and optically coupled to the lens.

The optical path changing member has a first face and a second face at different locations. The first face reflects a first wavelength of light transmitted between the optical waveguide member and the first optical device. The second face reflects a second wavelength of light transmitted between the optical waveguide member and the second optical device.

### FIELD OF THE INVENTION

The present invention relates to an optical module for optical communications.

### BACKGROUND ART

Optical modules for optically coupling an optical fiber and optical devices have been known in the art, as typified by the optical transceiver modules disclosed in Japanese Laid-Open Patent Publication Nos. 2004-264659, 2000-28850, 2005-331602, 9-325248 (1997), 62-89008 (1987), and 2005-250117. Some of such optical modules are optical transceiver modules used, for example, as optical subscriber terminals for FTTH networks and allow bidirectional transmission over a single optical fiber. These optical transceiver modules include, for example, a first package containing a light emitting device and a coupling lens, a second package containing a photodetector and a coupling lens, a multilayer dielectric film filter for combining/separating (or muxing/demuxing) transmitter and receiver wavelengths, and an optical fiber.

Various configurations have been proposed for optical modules to reduce their cost, etc. For example, the above Japanese Laid-Open Patent Publication No. 2004-264659 discloses an optical transceiver module that includes, in a single package, a light emitting device and a photodetector which are coupled to an optical fiber through the same lens. The common use of the lens reduces the parts count. Further, a diffracting grating having a function to combine/separate wavelengths is integrally molded with the lens. This arrangement also results in a reduction in the parts count.

Conventional optical modules are constructed such that the optical fiber and the lens are spaced by a predetermined first distance and the lens and the light emitting device or the photodetector are spaced by a predetermined second distance in order to establish appropriate optical systems for these optical devices (i.e., the light emitting device and the photodetector). However, with such optical modules, it is not always possible to form appropriate optical systems for both optical devices at the same time; a different optical device may require different first and second distances to establish a suitable optical system.

### SUMMARY OF THE INVENTION

The present invention has been devised to solve these problems. It is, therefore, an object of the present invention to provide an optical module in which an optimum optical system is established for each optical device with great design freedom while reducing the parts count.

According to one aspect of the present invention, an optical module includes an optical waveguide member for passing light therethrough and an optical path changing member for receiving and reflecting light. The optical path changing member is optically coupled to the optical waveguide member.

The optical module further includes a lens optically coupled to the optical path changing member. The optical module further includes a first optical device and a second optical device. The first optical device and the second optical device are disposed to face the optical path changing member through the lens and optically coupled to the lens.

The optical path changing member has a first face and a second face at different locations. The first face reflects a first wavelength of light transmitted between the optical waveguide member and the first optical device. The second face reflects a second wavelength of light transmitted between the optical waveguide member and the second optical device.

Other and further objects, features and advantages of the invention will appear more fully from the following description.

### BRIEF DESCRIPTION OF THE DRAWINGS

FIG. 1 is a diagram schematically showing the configuration of an optical module according to a first embodiment of the present invention.

FIG. 2 is a diagram illustrating how the transmission light and the reception light are separated from each other.

FIG. 3 shows the relationships between the filter angle θ₁ and the distance Δy for different filter thicknesses d.

FIG. 4 shows the relationships between the filter angle θ₁ and the distance Δz for different filter thicknesses d.

FIG. 5 shows a comparative optical module.

FIG. 6 is a diagram schematically showing a configuration of an optical module according to a first embodiment.

FIG. 7 is a diagram showing a comparative optical transceiver module.

FIG. 8 is a diagram showing other comparative optical transceiver module.

FIG. 9 shows how the optical module according to a first embodiment and comparative optical module are mounted on the substrate.

FIG. 10 is a diagram schematically showing the configuration of an optical module according to a second embodiment of the present invention.

FIG. 11 is a diagram schematically showing the configuration of an optical module according to a third embodiment of the present invention.

FIG. 12 is a diagram schematically showing the configuration of an optical module according to a fourth embodiment of the present invention.

FIG. 13 is a diagram schematically showing the configuration of an optical module according to a fifth embodiment of the present invention.

FIG. 14 is a diagram schematically showing the configuration of an optical module according to a sixth embodiment of the present invention.

FIG. 15 is a diagram schematically showing the configuration of an optical module according to a eighth embodiment of the present invention.

FIG. 16 is a diagram schematically showing the configuration of an optical module according to a ninth embodiment of the present invention.

FIG. 17 is a diagram schematically showing the configuration of an optical module according to a tenth embodiment of the present invention.

FIG. 18 is a diagram illustrating the optical systems for the light emitting device and the photodetector in an optical transceiver module of the tenth embodiment.

### DETAILED DESCRIPTION OF THE PREFERRED EMBODIMENTS

### First Embodiment

[Device Configuration of First Embodiment]

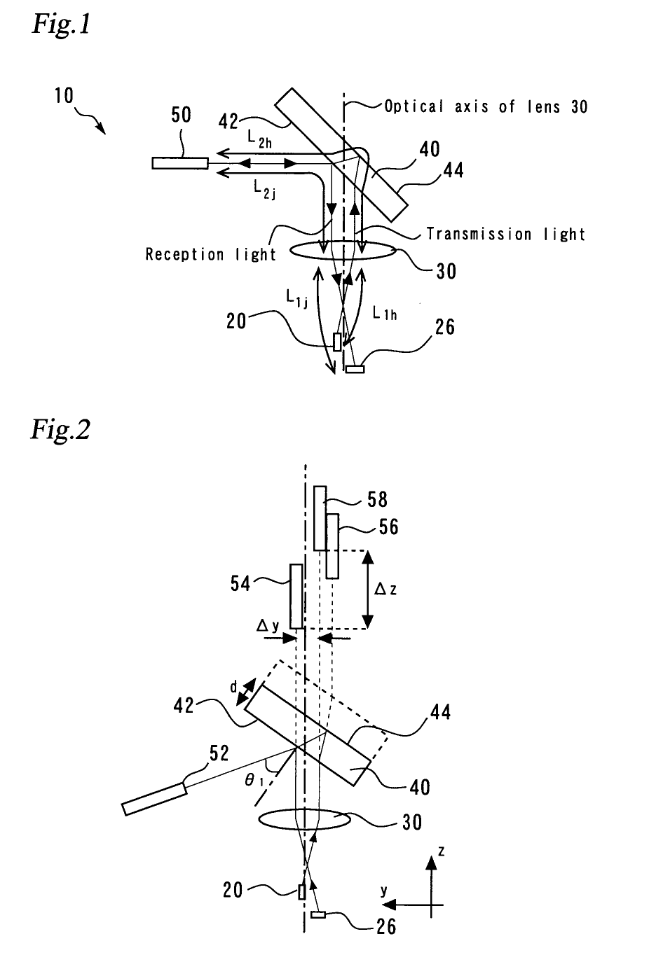

FIG. 1 is a diagram schematically showing the configuration of an optical transceiver module (10) according to a first embodiment of the present invention. Referring to the figure, the optical transceiver module 10 includes a light emitting device 20, a photodetector 26, a lens 30, a multilayer dielectric film filter 40, and an optical fiber 50.

The light emitted from the light emitting device 20 (hereinafter referred to as the “transmission light”) travels through the lens 30 and then through the first face 42 of the multilayer dielectric film filter 40 and is reflected by the second face 44 of the filter 40 and coupled into the optical fiber 50, as indicated by the line with arrows extending from the light emitting device 20 in FIG. 1. The light emerging from the optical fiber 50 (hereinafter referred to as the “reception light”), on the other hand, is reflected by the first face 42 of the multilayer dielectric film filter 40, converged by the lens 30, and coupled into the photodetector 26. In this way, the transmission light is delivered from the light emitting device 20 to the optical fiber 50, and the reception light is delivered from the optical fiber 50 to the photodetector 26.

The transmission light and the reception light each have a different wavelength. Although in FIG. 1 the transmission light is reflected by the second face 44 and the reception light is reflected by the first face 42, the optical module may be constructed such that the transmission light is reflected by the first face 42 and the reception light is reflected by the second face 44. It should be noted that herein and in the following description, as a general rule, the face of a multilayer dielectric film filter facing toward the optical fiber is referred to as a “first face,” and the opposite face is referred to as a “second face.”

FIG. 2 is a diagram illustrating how the transmission light and the reception light are separated from each other by the reflecting action of the first face 42 and the second face 44 of the multilayer dielectric film filter 40. The filter angle θ (i.e., the angle between the normal to the filter faces and the optical axis of the lens 30) is not limited to 45° (see FIG. 2).

Referring to FIG. 2, the virtual image (or mirror image) 54 of the optical fiber 52 produced by the reception light is spaced from the first face 42 by the same distance as the optical fiber 52 is spaced from the first face 42, since the light is reflected by the first face 42. Likewise, if the transmission light is assumed to be not refracted as it passes through the first face 42, the virtual image (or mirror image) 56 of the optical fiber 52 produced by the transmission light is spaced from the second face 44 by the same distance as the optical fiber 52 is spaced from the second face 44, since the light is reflected by the second face 44.

However, the substrate of the multilayer dielectric film filter 40 is usually made of glass having a refractive index of approximately 1.5, meaning that the transmission light is refracted when it passes through the first face 42. The virtual image of the optical fiber 52 produced by the transmission light in this case is indicated by reference numeral 58. Thus, the virtual images 54 and 58 of the optical fiber 52 produced by the reception light and the transmission light, respectively, are located at different positions, which allows the transmission and reception light to be separated from each other (see FIG. 2).

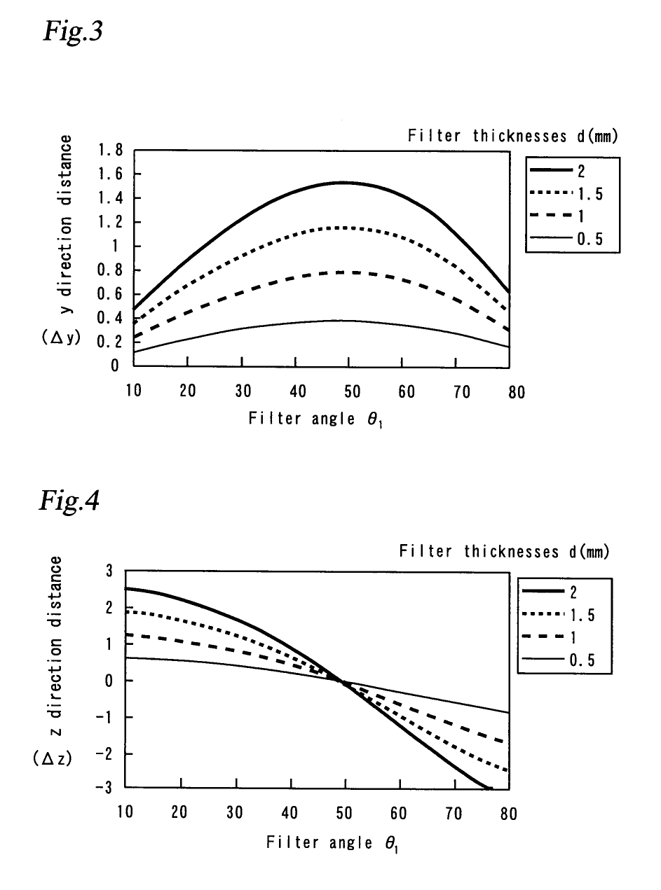

The distances Δy and Δz between the virtual images 54 and 58 in the y- and z-directions, respectively, as viewed in FIG. 2, are determined by the filter thickness d and the filter angle θ₁. FIG. 3 shows the relationships between the filter angle θ₁ and the distance Δy for different filter thicknesses d. These relationships were obtained by paraxial approximation. FIG. 4 shows the relationships between the filter angle θ₁ and the distance Δz for different filter thicknesses d. These relationships were also obtained by paraxial approximation. FIG. 4 indicates that the larger the filter thickness, the larger the distance Δy and hence the larger the distance between the light emitting device and the photodetector in the y-direction.

For the same filter thickness, the distance Δy and hence the distance between the light emitting device and the photodetector in the y-direction are maximized when the filter angle is approximately 50°. The distance Δz between the virtual images 54 and 58 in the z-direction, i.e., the optical axis direction, depends on the filter angle rather than the filter thickness. The parameters of the filter are determined by the required difference between the optical magnifications of the transmitter and receiver sides and the required distance between the light emitting device 20 and the photodetector 26.

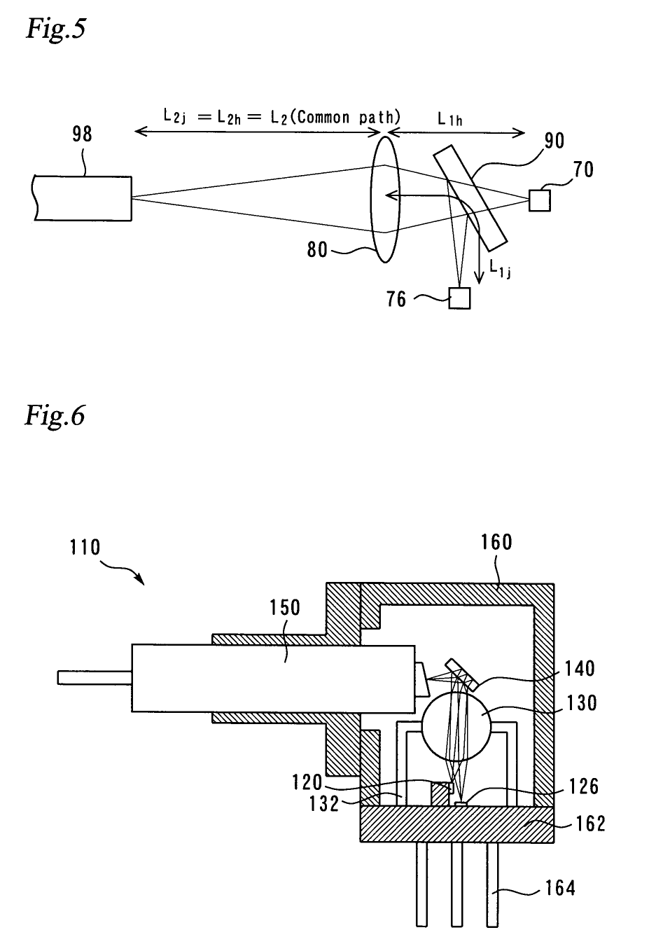

Thus, the optical module of the present embodiment is constructed such that the multilayer dielectric film filter is disposed between the optical fiber and the lens. The advantages of this optical module will be described by comparing it with a comparative optical module in which the multilayer dielectric film filter is disposed between the lens and the optical devices (i.e., the light emitting device and the photodetector). FIG. 5 shows the comparative optical module. Reference numeral 90 denotes the multilayer dielectric film filter; 80, the lens; 70, the light emitting device; 76, the photodetector; and 98, the optical fiber.

In order that the optical system for the light emitting device have sufficient coupling efficiency, it must be constructed such that the ratio L₁ₕ:L₂ₕ=1:2-5, where L₁ₕ is the optical distance between the light emitting device and the lens and L₂ₕ is the optical distance between the lens and the optical fiber. That is, L₁ₕ must be longer than L₂ₕ. As for the optical system for the photodetector, it is preferably constructed such that the ratio L₁ⱼ:L₂ⱼ=1:1, where the L₁ⱼ is the optical distance between the photodetector and the lens and L₂ⱼ is the optical distance between the lens and the optical fiber. Since in FIG. 5 the multilayer dielectric film filter 90 is disposed between the lens and the optical devices (i.e., the light emitting device 70 and the photodetector 76), the optical systems for the light emitting device 70 and the photodetector 76 share the same lens-to-fiber optical path, that is, the lens-to-fiber optical distance L₂ₕ in the optical system for the light emitting device 70 is the same as the lens-to-fiber optical distance L₂ⱼ in the optical system for the photodetector. That is, L₂ₕ=L₂ⱼ=L₂, as shown in FIG. 5.

Incidentally, when an image of an object is formed by a lens, the following equation relates the focal length f of the lens to the distances L₁ and L₂ of the object and image, respectively, from the lens:

1/L₁+1/L₂=1/f.

That is to say, the image-to-lens distance L₂ depends on the focal length f and the object-to-lens distance L₁. This means that in the case of the above comparative optical module it is impossible or difficult to simultaneously satisfy the conditions L₁ₕ:L₂ₕ=1:2-5 and L₁ⱼ:L₂ⱼ=1:1 since the optical systems for the light emitting device and the photodetector share the same lens and L₂ₕ=L₂ⱼ=L₂, as described above. That is, the configuration of the comparative optical module does not provide much mounting space and design flexibility, making it difficult to mount components at desired locations.

On the other hand, the optical module of the present embodiment is constructed such that the multilayer dielectric film filter 40 is disposed between the lens and the optical fiber. Therefore, different lens-to-fiber optical paths can be established in the optical systems for the light emitting device and the photodetector, respectively, as shown in FIG. 1. That is, it is possible to set or adjust the optical distances L₁ⱼ and L₂ⱼ in the optical system for the photodetector 76 independently of the optical distances L₁ₕ and L₂ₕ in the optical system for the light emitting device 70, and vice versa, by changing the thickness of the multilayer dielectric film filter 40 and its position relative to the optical fiber. This increase the design flexibility and facilitates mounting of components at desired locations.

Further, according to the present embodiment, the transmission light and the reception light are caused to travel different optical paths by reflecting them using the multilayer dielectric film filter 40. This allows these optical paths to be different in length by an amount at least as great as the thickness of the filter substrate. Therefore, it is easy to design the optical systems for the light emitting device 70 and the photodetector 76 independently of each other so as to form the optical paths L₁ⱼ and L₂ⱼ in the optical system for the photodetector 76 differently from the optical paths L₁ₕ and L₂ₕ in the optical system for the light emitting device 70.

Further, according to the present embodiment, the front and back faces of the multilayer dielectric film filter are used to reflect the reception light and the transmission light, respectively, and thereby cause the images produced by them to be focused at different locations. It should be noted that since multilayer dielectric film filters combine/separate (or mux/demux) wavelengths with only small loss, the present embodiment can increase the design flexibility of the optical systems of an optical module without a significant increase in loss.

[Illustrative Implementations of Optical Module of First Embodiment]

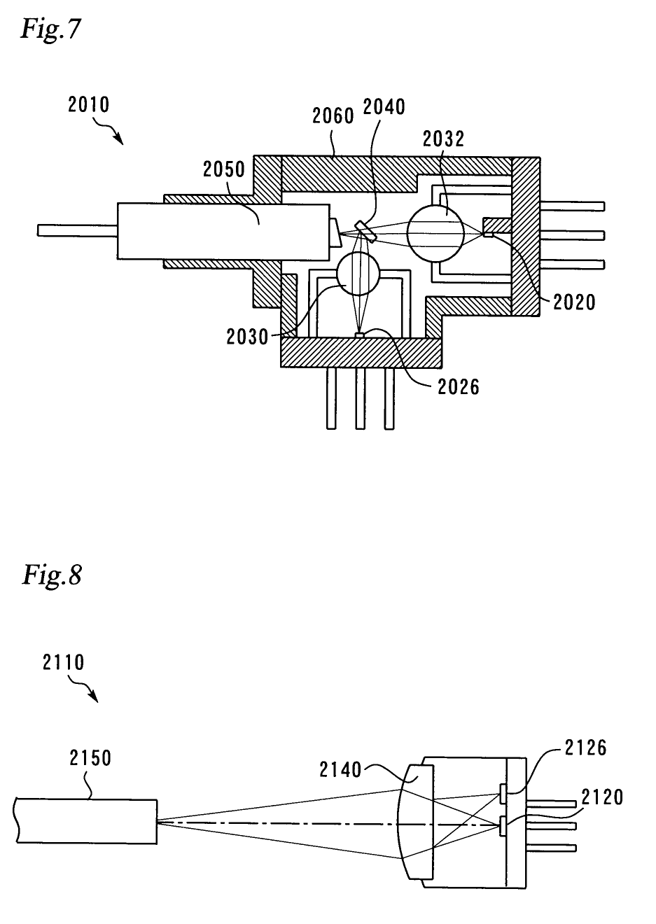

There will now be described an illustrative implementation (shown in FIG. 6) of the optical transceiver module of the present embodiment. Specifically, the advantages of this implementation will be described by comparing it with the comparative optical transceiver modules shown in FIGS. 7, 8, and 9. It should be noted that in the following figures thin solid lines are used to indicate light transmitted between optical components including optical devices, lenses, an optical fiber, and a multilayer dielectric film filter.

FIG. 6 shows the configuration of an optical transceiver module 110 according to the present embodiment. This optical transceiver module includes a metal case 160 and includes a package (or assembly) and a multilayer dielectric film filter 140 which are mounted in the case 160. The package includes a light emitting device 120, a photodetector 126, a coupling lens 130, and a metal cap 132 to which the coupling lens 130 is fixed. The optical transceiver module 110 is characterized in that the light emitting device 120 and the photodetector 126 are hermetically enclosed by the metal cap 132, the coupling lens 130, and a stem 162 (described later). Since such hermetic enclosing can be done by a known method such as that used to form what is called a CAN package, a detailed description thereof will not be provided herein. It should be noted that the lens 130 of the optical transceiver module 110 is a ball lens, not an ordinary convex lens, although the components are arranged in the same manner as in the optical transceiver module 10.

The stem 162 (a metal base) is provided with power supply terminals 164 to transmit or receive signals. These supply terminals are fixed to the stem 162 by frit glass so as to hermetically seal the inside of the metal case 160. The light emitting device 120 and the photodetector 126 are mounted on the stem 162. The stem 162 (with the optical devices mounted thereon) is fixed to the metal case 160, and the multilayer dielectric film filter 140 is fixed at a predetermined angle. With this arrangement, an optical fiber 150 is inserted into the case 160 and aligned for appropriate optical coupling before being fixed by welding.

Thus, the configuration of the optical transceiver module of the present embodiment allows the light emitting device and the photodetector to be spaced in appropriate proximity to each other and thereby housed in the same package (as shown in FIG. 6) while establishing a substantially independent optical system for each optical device by using the same lens, as described with reference to FIGS. 3 and 4. That is, the wavelength combining/separating module is manufactured with fewer parts than conventional wavelength combining/separating modules. Further, the module requires only a single operation to align the optical axis of the optical fiber 150, resulting in a reduction in the number of manufacturing process steps. It should be noted that (the end face of) the optical fiber 150 may be ground to an angle of 8° to reduce return loss.

FIG. 7 is a diagram showing a first comparative optical transceiver module 2010. This optical transceiver module includes a case 2060 and includes two packages (or assemblies), a multilayer dielectric film filter 2040, and an optical fiber 2050 which are mounted in the case 2060. One of the two packages includes a light emitting device 2020 and a coupling lens 2032, and the other package includes a photodetector 2026 and a coupling lens 2030. The multilayer dielectric film filter 2040 is used to combine/separate (or mux/demux) transmitter and receiver wavelengths.

The transmission light emitted from the light emitting device 2020 passes through the coupling lens 2032 and through the multilayer dielectric film filter 2040 and enters the optical fiber 2050. The reception light emerging from the optical fiber 2050, on the other hand, is reflected by the multilayer dielectric film filter 2040 and coupled into the photodetector 2026 through the coupling lens 2030. In FIG. 7, solid lines are used to indicate the transmission and reception light.

Thus, the optical transceiver module shown in FIG. 7 includes two separate packages containing the light emitting device and the photodetector, respectively, resulting in an increase in the size of the module and in the parts count. On the other hand, in the optical transceiver module of the present embodiment, the light emitting device and the photodetector are contained in the same package to reduce the size and parts count of the module.

FIG. 8 is a diagram showing a second comparative optical transceiver module 2110. Incidentally, various configurations have been proposed for optical transceiver modules to reduce their cost. For example, Japanese Laid-Open Patent Publication No. 2004-264659 noted above discloses a method for housing the light emitting device and the photodetector in the same package and establishing their coupling to the optical fiber by using the same common lens. The optical transceiver module 2110 shown in FIG. 8 has a similar configuration.

The optical transceiver module 2110 includes a DOE (diffractive optical element) lens 2140 made up of a diffraction grating functioning to combine/separate wavelengths and a coupling lens integrally formed with the diffraction grating. The optical fiber (2150) is optically coupled to the light emitting device (2120) and the photodetector (2126) through the DOE lens 2140. This configuration allows for a reduction in the parts count, as described in the above patent publication.

However, the use of the diffraction grating for combining/separating wavelengths incurs optical power loss, which may result in a reduction in the coupling efficiency between the light emitting device and the optical fiber and between the photodetector and the optical fiber. To improve the diffraction efficiency, the size of the module may be increased. However, this causes various problems, including increased mounting space. On the other hand, the optical transceiver module of the present embodiment employs a multilayer dielectric film filter, instead of a DOE lens, which allows a reduction in the parts count and an increase in the design flexibility for the optical systems while reducing the loss. That is, it is possible to effectively reduce the module size.

It should be noted that the above patent publication also discloses an optical transceiver module having a configuration similar to that of the optical transceiver module 2110 except that it employs a separate diffraction grating and a separate lens, instead of a DOE lens. In this module, the diffractive optical element (or the diffraction grating) is disposed between the optical fiber and the lens, meaning that different fiber-to-lens optical paths are established for the light emitting device and the photodetector, respectively. That is, the fiber-to-lens optical distance in the optical system for the light emitting device differs from that in the optical system for the photodetector, as in the first embodiment. However, the use of the diffraction grating incurs optical power loss, which may require an increase in the module size, as described above. This may place constraints on the design flexibility, requiring a further improvement in the module.

On the other hand, the optical transceiver module of the present embodiment employs a multilayer dielectric film filter, which causes only a small optical power loss, to combine/separate wavelengths of light, thereby increasing the design flexibility. Further, according to the present embodiment, the transmission light and the reception light are caused to travel different optical paths by reflecting them using the multilayer dielectric film filter, as described above. This makes it easy to design the optical systems for the light emitting device and the photodetector independently of each other.

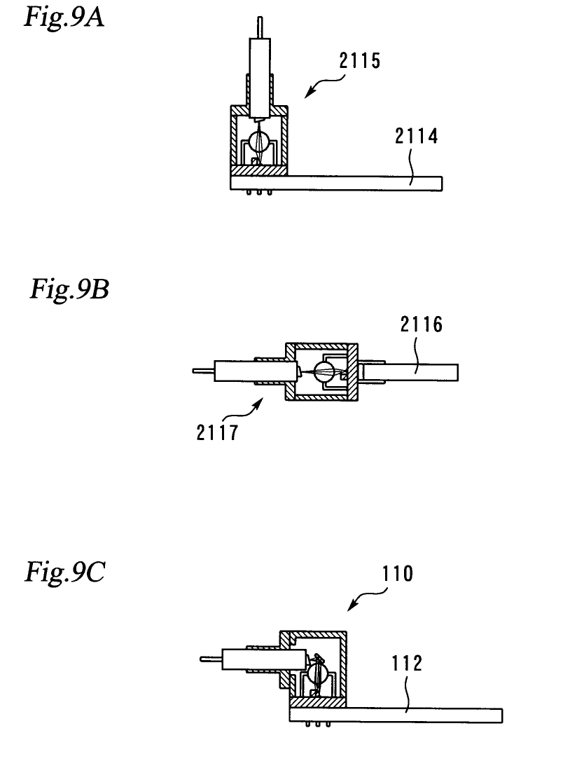

The optical transceiver module (110) of the present embodiment also has an advantage in that the module is easy to mount on the substrate. FIGS. 9A and 9B each show, for comparison, how a “coaxial” module is mounted on the substrate. FIG. 9C shows how the optical transceiver module 110 is mounted on the substrate.

Referring to FIG. 9A, a “coaxial” optical transceiver module 2115 is mounted on a substrate 2114 such that its optical fiber extends perpendicular to the substrate. This arrangement tends to complicate the routing of the optical fiber. In FIG. 9B, on the other hand, a “coaxial” optical transceiver module 2117 is mounted on a substrate 2116 such that the optical fiber extends parallel or in alignment with the substrate to facilitate the routing of the optical fiber. However, this arrangement may leads to difficulty in assembly, e.g., it may be difficult to solder bond the power supply terminals of the optical transceiver module 2117 to the substrate.

FIG. 9C shows the optical transceiver module 110 mounted on a substrate 112. In this case, although the power supply terminals 164 of the optical transceiver module 110 are inserted perpendicularly into the substrate 112, the optical fiber 150 extends parallel to the substrate. This facilitates the routing of the optical fiber 150, as well as facilitating the assembly. Thus, the optical transceiver module of the present embodiment has a reduced parts count and hence a reduced cost. Further, the configuration of the module allows it to be manufactured at a reduced cost.

[Variations of First Embodiment]

(First Variation)

Although the optical transceiver module of the present embodiment has been described as including a light emitting device and a photodetector, the embodiment is not limited to this particular configuration, but can be applied to other optical modules depending on the application intended. For example, the optical transceiver module may include two light emitting devices or two photodetectors, instead of one light emitting device and one photodetector.

(Second Variation)

Although the optical transceiver module 110 of the present embodiment has been described as employing a ball lens (130), it may alternatively use the convex lens described in connection with the optical transceiver module 10 of the present embodiment. It should be noted that the use of a ball lens instead of a convex lens reduces the cost of the optical transceiver module, since ball lenses are low in price.

(Third Variation)

Although the optical transceiver module of the present embodiment has been described as employing an optical fiber (50), the present invention is not limited to optical fibers, but can be applied to various optical waveguide components.

(Fourth Variation)

In the optical transceiver module of the present embodiment, a multilayer dielectric film filter is provided between the lens and the optical fiber to combine/separate wavelengths of light and to allow formation of different optical paths to the light emitting device and the photodetector, respectively. The multilayer dielectric film filter is provided with various films to achieve such a function. However, the present invention is not limited to multilayer dielectric film filters. For example, a prism may be used instead of a multilayer dielectric film filter to reflect light and thereby provide different optical paths.

### Second Embodiment

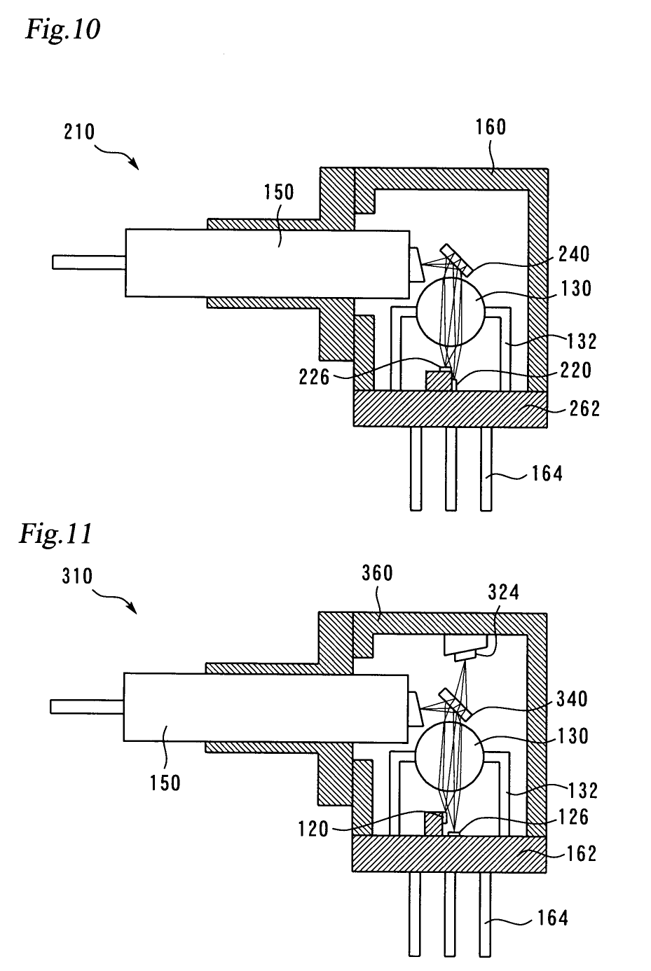

FIG. 10 is a diagram illustrating an optical transceiver module 210 according to a second embodiment of the present invention. It should be noted that in the following description, like numerals will be used to denote like components described with reference to the first embodiment in order to avoid undue repetition. The optical transceiver module 210 of the present embodiment is similar to that of the first embodiment except that the relative positions of the light emitting device and the photodetector have been switched. Referring to FIG. 10, a light emitting device 220 and a photodetector 226 are mounted on a stem 262. The multilayer dielectric film filter (240) of the present embodiment has on its first face (i.e., the left face as viewed in FIG. 10) a film having a function to reflect the transmission light and transmit the reception light. Further, the multilayer dielectric film filter 240 has on its second face (i.e., the right face as viewed in FIG. 10) a film having a function to reflect the reception light.

In the present embodiment, unlike the first embodiment, the receiver-side optical system has a magnification of less than 1 (when the magnification of the transmitter-side optical system is high). Use of a lens with low aberration makes the configuration of the present embodiment practical. (With a lens with high aberration, when the receiver side has a magnification significantly lower than 1, the coupling loss may increase.) Thus, the present invention allows the relative positions of the optical devices to be switched as necessary.

### Third Embodiment

FIG. 11 is a diagram illustrating the configuration of an optical transceiver module 310 according to a third embodiment of the present invention. It should be noted that like numerals will be used to denote like components described with reference to the above embodiments in order to avoid undue repetition. Referring to FIG. 11, the optical transceiver module 310 includes a monitor photodetector 324 mounted on its case 360 to monitor the optical output power of the light emitting device (120). It should be noted that since the light emitting device 120 and the photodetector 126 are disposed in close proximity to each other within the hermetically sealed package, a common monitor photodetector for a transmitter module is difficult to mount in this optical transceiver module.

To solve this problem, the optical transceiver module of the present embodiment includes a multilayer dielectric film filter 340 whose second face (the face facing the upper right in FIG. 11) has thereon a film functioning not only to reflect but also to slightly transmit the transmission light. This causes a portion of the transmission light to be coupled into the monitor photodetector 324 mounted on the ceiling of the case 360, thereby allowing the output of the light emitting device 120 to be determined by measuring the current of the monitor photodetector 324.

### Fourth Embodiment

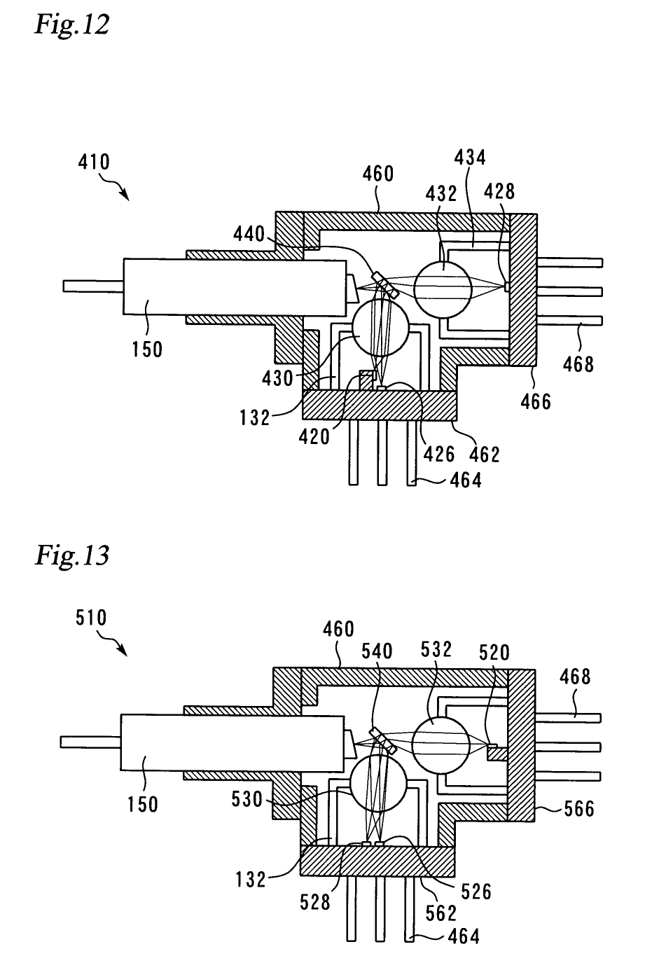

FIG. 12 is a diagram illustrating the configuration of an optical transceiver module 410 according to a fourth embodiment of the present invention. This optical transceiver module receives light including two different wavelengths of light (hereinafter referred to as “first reception light” and “second reception light,” respectively) from the optical fiber 150 and separates these wavelengths of light.

The optical transceiver module 410 includes a case 460 and stems 462 and 466 and includes first and second airtight packages and a multilayer dielectric film filter 440 which are mounted in the case 460. The first airtight package includes a lens 430, a light emitting device 420, a photodetector 426, and a metal cap 132 for sealing the package. The second airtight package includes a lens 432, a photodetector 428, and a metal cap 434 for sealing the package. The first package is mounted on the stem 462, and the second package is mounted on the stem 466. The stems 462 and 466 are provided with power supply terminals 464 and 468, respectively.

According to the present embodiment, the multilayer dielectric film filter 440 is designed such that the second reception light transmits through the first and second faces of the filter. (It should be noted that as for the transmission light and the first reception light, the multilayer dielectric film filter 440 functions in the same manner as the multilayer dielectric film filters of the first to third embodiments.) That is, the films on the first and second faces of the multilayer dielectric film filter 440 allow the second reception light to pass through. This enables the second reception light to be coupled into the photodetector 428.

Conventional optical transceiver modules for receiving two wavelengths of light require three packages (each including a lens) to handle the transmission light and the reception light (including the two wavelengths of light). On the other hand, the optical transceiver module of the present embodiment requires only two packages to achieve the same function.

### Fifth Embodiment

A fifth embodiment of the present invention provides an improvement over the fourth embodiment. FIG. 13 is a diagram illustrating the configuration of an optical transceiver module 510 of the fifth embodiment.

Referring to FIG. 13, the optical transceiver module 510 includes stems 562 and 566 and includes first and second packages and a multilayer dielectric film filter 540 which are mounted in the case 460. The first package includes photodetectors 526 and 528 and a common coupling lens 530 for optically coupling these photodetectors to the optical fiber 150, and the second package includes a light emitting device 520 and a coupling lens 532 for optically coupling the device to the optical fiber 150.

The photodetectors 526 and 528 are mounted on the stem 562, and the light emitting device 520 is mounted on the stem 566. In order to allow the optical transceiver device 510 to receive and separate two wavelengths of light (or first reception light and second reception light), a first face of the multilayer dielectric film filter 540 has thereon a film functioning to reflect the first reception light and transmit the second reception light and the transmission light. A second face of the multilayer dielectric film filter 540, on the other hand, has thereon a film functioning to reflect the second reception light and transmit the transmission light.

The first and second packages are disposed at different locations, as shown in FIG. 13. Thus, in the fifth embodiment, unlike the fourth embodiment, the light emitting device is mounted in a different package than the photodetectors. This prevents interference between the transmitter side and receiver side. (It should be noted that the electrical signal of the light emitting device is larger in magnitude than that of the photodetectors.)

### Sixth Embodiment

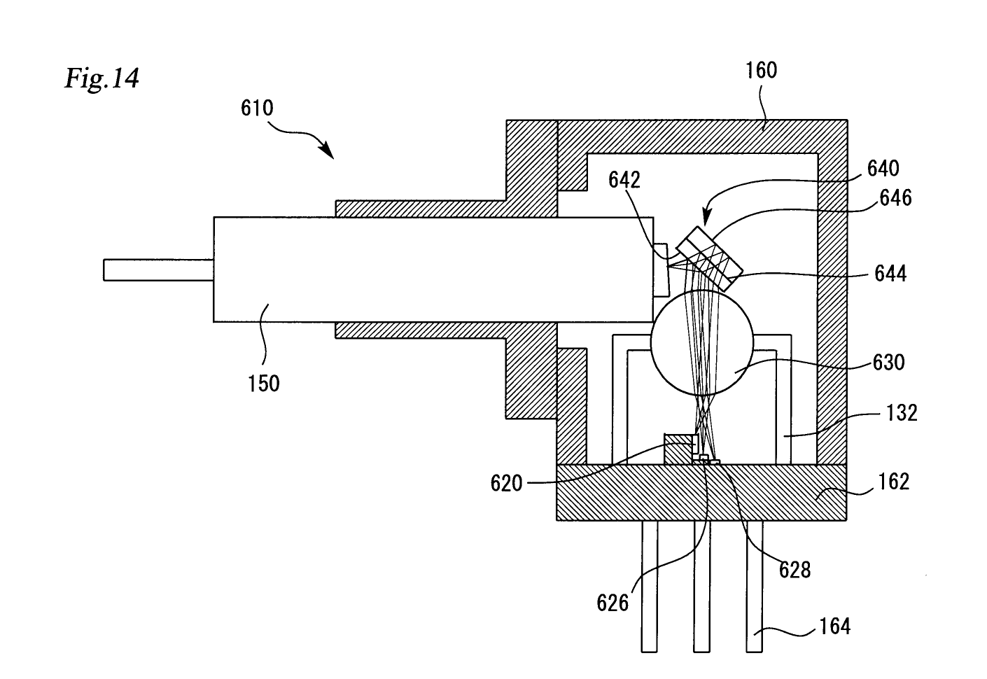

A sixth embodiment of the present invention provides a simpler module configuration than the fourth and fifth embodiments. FIG. 14 is a diagram illustrating an optical transceiver module 610 of the sixth embodiment. Referring to FIG. 14, the optical transceiver module 610 includes a package, a multilayer dielectric film filter 640, and the optical fiber 150 which are mounted in the case 160. The package includes a lens 630, a light emitting device 620, and photodetectors 626 and 628. The light emitting device 620 and the photodetectors 626 and 628 are mounted on the stem 162 and hermetically sealed, as in the first embodiment. The first reception light is coupled into the photodetector 626, and the second reception light is coupled into the photodetector 628.

According to the present embodiment, the multilayer dielectric film filter 640 includes stacked first and second substrates, that is, it has three interfaces; namely, the outer face of the first substrate (hereinafter referred to as the first face 642), the interface between the first and second substrates (hereinafter referred to as the second face 644), and the outer face of the second substrate (hereinafter referred to as the third face 646), as shown in FIG. 14. The first face 642 has thereon a film to reflect the second reception light and transmit the first reception light and the transmission light. The second face 644 has thereon a film to reflect the first reception light and transmit the transmission light. Further, the third face 646 has thereon a film to reflect the transmission light. With this arrangement, the images produced by the three wavelengths of light (i.e., the transmission light and the first and second reception light) can be focused at different locations (in relatively close proximity), thereby allowing the light emitting device 620 and the photodetectors 626 and 628 to be mounted in the same common package. That is, the three wavelengths of light can be combined/separated using a single package.

### Seventh Embodiment

An optical transceiver module according to a seventh embodiment of the present invention differs from that of an above embodiment of the present invention in that its coupling lens is a ball lens, which is inexpensive. This allows the optical transceiver module to be manufactured at low cost. Ball lenses are disadvantageous in that they have high spherical aberration. However, the coupling ball lens may be formed of glass having a high refractive index to provide a transmission coupling efficiency of 25% or more. Coupling efficiency of this magnitude is sufficient for subscriber terminals for FTTH networks since the power of the light transmitted by these terminals is considerably higher than that required by the network system.

### Eighth Embodiment

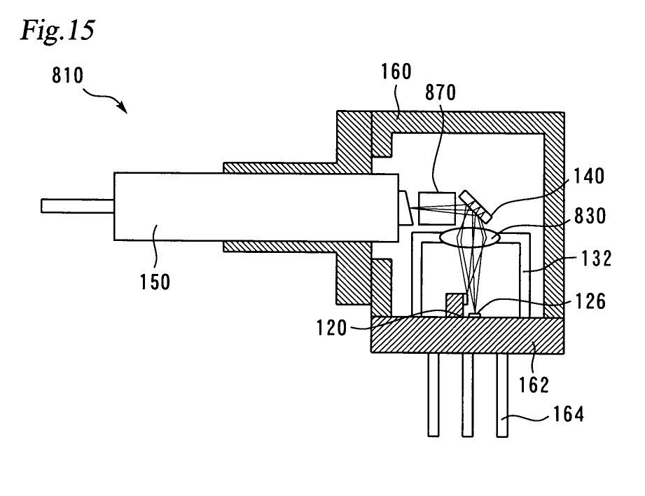

FIG. 15 is a diagram illustrating the configuration of an optical transceiver module 810 according to the eighth embodiment of the present invention. This optical transceiver module is characterized in that its coupling lens 830 is a aspherical lens. It should be noted that although ball lenses are inexpensive, they have high spherical aberration which results in a reduction in the coupling efficiency when the focal length is large. The transmission coupling efficiency provided by a ball lens is at most 20-35%, since there is a trade-off between the aberration and the mode coupling efficiency.

Aspherical lenses have a function of adjusting spherical aberration and hence can provide a transmission coupling efficiency of 50% or more. Furthermore, the use of a long focal length aspherical lens enables increasing the back focal length (i.e., the distance from the optical fiber to the closest point on the lens), thereby allowing an isolator (870) to be inserted between the optical fiber and the lens, as shown in FIG. 15. Thus, since the optical transceiver module of the present embodiment is adapted to achieve high coupling efficiency and include an isolator (870), it can be used in station terminals of the system as well as in subscriber terminals.

### Ninth Embodiment

An optical transceiver module according to a ninth embodiment of the present invention differs from that of the eighth embodiment shown in FIG. 15 in that the isolator 870 is replaced by a higher performance isolator (described below). The following description will be directed to the configuration of this isolator, and the components that are common to FIG. 15 will not be described herein.

According to the present embodiment, a polarization-independent-type isolator is disposed between the filter and the fiber (as in the eighth embodiment), and the isolator includes a Faraday rotator and two birefringent crystals. In such an arrangement, the isolator must be of the polarization independent type, since both the transmission light and the reception light must travel through the isolator. More specifically, if the isolator is of the polarization dependent type, the reception light may not be able to pass through it (that is, the light may be completely absorbed by the isolator), depending on the polarization direction of the light. Therefore, the isolator of the present embodiment is a polarization independent isolator.

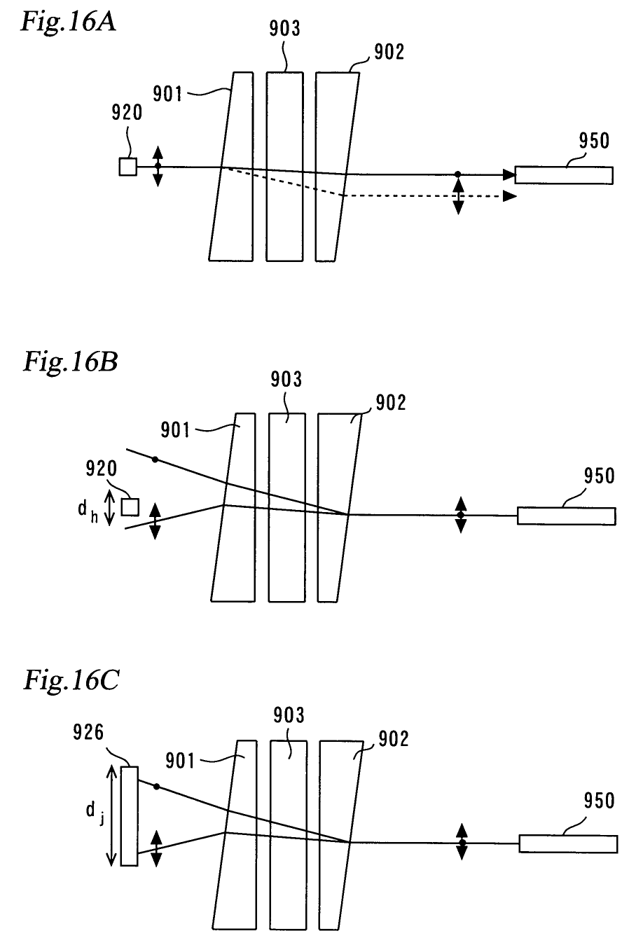

The structure and function of the polarization independent isolator of the present embodiment will now be described with reference to FIG. 16 (including FIGS. 16A to 16C). In FIG. 16, the arrowed solid and broken lines indicate light coupled into an optical fiber 950 through the polarization independent isolator. Specifically, each arrowed solid line represents a light beam polarized (i.e., vibrating) perpendicular to the plane of the paper. Each arrowed broken line, on the other hand, represents a light beam polarized (i.e., vibrating) parallel to the plane of the paper. It should be noted that each dot () indicates that the light beam vibrates perpendicular to the plane of the paper, and each double arrowed short line indicates that the light beam vibrates parallel to the plane of the paper. Further, the (transmission) light beam emitted from the light emitting device (920) is represented by a solid line bearing both a dot () and a double arrowed short line until it reaches the birefringent crystal 901, where it is subjected to polarization (and refraction). Likewise, the reception light beam output from the optical fiber and the portion of the transmission light beam reflected or returned by the optical fiber are also each represented by a solid line bearing both a dot () and a double arrowed short line until they reach the birefringent crystal 902, where they are subjected to polarization (and refraction).

FIG. 16A shows the paths traveled by the transmission light emitted from the light emitting device (920). Referring to FIG. 16A, the light beam emitted from the light emitting device 920 passes through the polarization independent isolator where it is split into two differently polarized beams by the combination of two birefringent crystals 901 and 902 and a Faraday rotator 903 before one or both of these beams reach the optical fiber 950. Generally, the light emitting device of an optical communications module emits light polarized only in one direction (in FIG. 16, perpendicular to the plane of the paper). That is, it is only necessary to adjust the position of the fiber so as to receive this unidirectionally polarized light.

FIG. 16B shows the paths of the portion of the transmission light reflected or returned by the optical fiber 950. It should be noted that the return light is polarized in random directions. When the return light travels through the birefringent crystals and the Faraday rotator, the components of light polarized parallel and perpendicular to the plane of the paper are refracted in different directions such that they are diverted from striking the emitting point of the light emitting device. It should be noted that the spot size dₕ of the light emitting device 920 is small (approximately 1 μm). Therefore, the amount of refraction can be set such that the return light is not coupled into the light emitting device 920 to achieve an isolator function.

The reception light traveling through the isolator is also polarized in random directions. As the reception light travels through the isolator, the components of light polarized parallel and perpendicular to the plane of the paper are also refracted in different directions, and the reception light travels the same optical paths as the above return light. However, since the size dⱼ of the light receiving surface 926 of the photodetector is approximately 20-80 μm (which is significantly larger than the spot size of the light emitting device), the amount of refraction of the components of the reception light polarized parallel and perpendicular to the plane of the paper can be set such that the reception light is coupled into the photodetector, as shown in FIG. 16C. In the present embodiment, the polarization independent isolator is formed so that the distance of two differently polarized components of light traveling to opposite direction is larger than the spot size and smaller than the diameter of the light receiving surface. That is, in the polarization independent isolator of the present embodiment, two differently polarized components of light traveling from the optical fiber to the light emitting device and the photodetector are refracted such that they are diverted from each other to such an extent that the light falls on the photodetector but does not fall on the light emitting device. This arrangement allows the isolator to function with the transmission light without affecting the coupling of the reception light into the photodetector.

### Tenth Embodiment

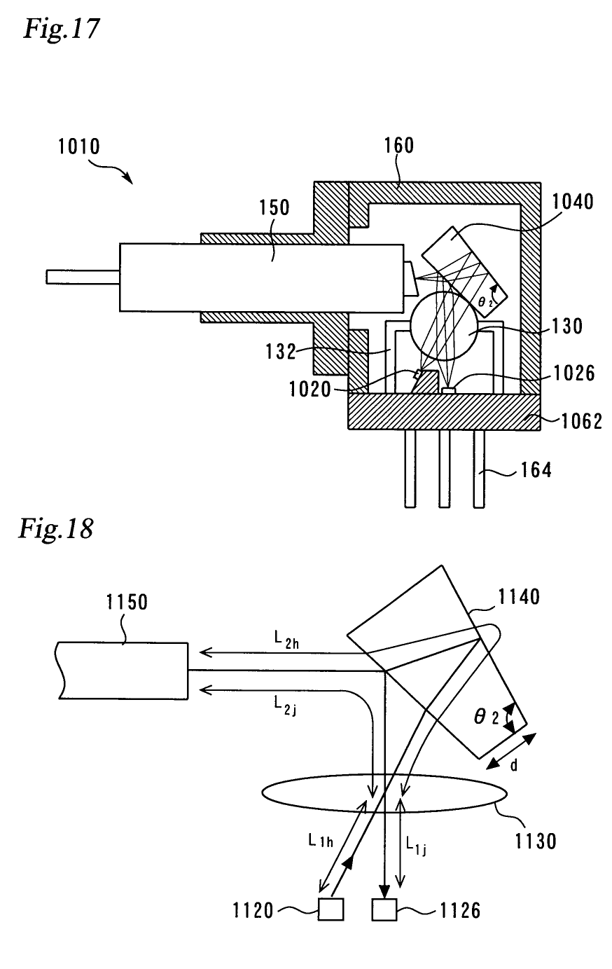

FIG. 17 is a diagram illustrating the configuration of an optical transceiver module 1010 according to a tenth embodiment of the present invention. This optical transceiver module is characterized in that it employs a multilayer dielectric film filter 1040 having first and second faces that are nonparallel to each other (hereinafter also referred to as a “wedge filter”). This wedge filter is used to reflect the transmission light and the reception light at different angles. Referring to FIG. 17, reference numeral 1062 denotes a stem, 1020 denotes a light emitting device, and 1026 denotes a photodetector.

As shown in FIG. 17, the optical path traveled by the transmission light within the lens 130 can be changed by changing the meeting angle (θ₂) of the second face with an adjacent face (or third face) of the wedge filter. Likewise, the optical path traveled by the reception light within the lens 130 can be changed by changing the meeting angle of the first face with the third face of the wedge filter. This allows both the transmission and reception light to travel through the center of the lens 130, thereby minimizing the influence of the coma aberration of the ball lens 130 on the system (as compared to the first to eighth embodiments) and preventing a reduction in the coupling efficiency. Furthermore, the distance between the light emitting device 1020 and the photodetector 1026 can be increased by adjusting the meeting angles of the first and second faces with the adjacent third face described above. This results in reduced crosstalk and increased maximum allowable clearance when the devices are mounted.

Further, the wedge filter of the present embodiment permits greater flexibility in designing optical transceiver modules than is available with the wedge filter of the first embodiment, as described below with reference to FIG. 18. FIG. 18 is a diagram illustrating the optical systems for the light emitting device and the photodetector in an optical transceiver module of the present embodiment. Referring to the figure, a filter 1140 is disposed between an optical fiber 1150 and a lens 1130, as in the first embodiment. This arrangement enables one to set or adjust the optical distances L₁ₕ and L₂ₕ in the optical system for the light emitting device (1120) independently of the optical distances L₁ⱼ and L₂ⱼ in the optical system for the photodetector (1126), and vice versa (see FIG. 18). It should be noted that the adjustment of these optical distances can be made by adjusting the position of the optical fiber 1150 relative to the filter 1140 and the thickness d of the filter 1140, as described in connection with the first embodiment.

Further, according to the present embodiment, the optical distances L₁ⱼ, L₂ⱼ, L₁ₕ, and L₂ₕ can also be adjusted by changing the meeting angles of the first and second faces with the adjacent third face of the filter. This prevents a reduction in the coupling efficiency and permits establishing a sufficient distance between the light emitting device and the photodetector, resulting in increased design flexibility.

Although in the present embodiment the first and second faces of the wedge filter are flat, it will be understood that they may have any surface configuration without departing from the sprit and scope of the present invention. For example, the first and second faces may include a curved portion or portions or have irregularities.

According to the present embodiment, by setting the meeting angles of the first and second faces with the adjacent third face of the wedge filter 1040 to suitable values, the angles of these faces with respect to the direction of the optical fiber 150 are set such that the reception light and the transmission light reflected by the first and second faces, respectively, travel through the center portion of the lens 130. In other embodiments, however, these meeting angles may be set to other suitable values to optimize the optical systems for the light emitting device and the photodetector depending on the application intended.

The features and advantages of the present invention may be summarized as follows: according to the first aspect of the present invention, the first wavelength of light coupled into the first optical device is coupled into the optical waveguide member by way of the lens and the first face of the optical path changing member. The second wavelength of light coupled into the second optical device, on the other hand, is coupled into the optical waveguide member by way of the lens and the second face of the optical path changing member. This enables one to set or adjust the optical distance between the first optical device and the lens independently of the optical distance between the second optical device and the lens, and vice versa. Further, it is also possible to set or adjust the optical distance traveled by the first wavelength of light between the optical waveguide member and the lens independently of the optical distance traveled by the second wavelength of light between the optical waveguide member and the lens, and vice versa. Further according to the first aspect of the invention, the first and second wavelengths of light are reflected by the first and second faces, respectively, of the optical path changing member. This makes it easy to cause the first and second wavelengths of light to travel different optical paths and thereby to design the optical systems for the first and second optical devices independently of each other.

Obviously many modifications and variations of the present invention are possible in the light of the above teachings. It is therefore to be understood that within the scope of the appended claims the invention may be practiced otherwise than as specifically described.

The entire disclosure of a Japanese Patent Application No. 2007-183554, filed on Jul. 12, 2007 including specification, claims, drawings and summary, on which the Convention priority of the present application is based, are incorporated herein by reference in its entirety.

What is claimed is:

1. An optical module comprising:
an optical waveguide member for passing light therethrough;
an optical path changing member for receiving and reflecting light, said optical path changing member being optically coupled to said optical waveguide member;
a lens optically coupled to said optical path changing member; and
a first optical device and a second optical device disposed to face said optical path changing member through said lens and optically coupled to said lens;
wherein said optical path changing member has a first face and a second face at different locations;
wherein said first face reflects a first wavelength of light transmitted between said optical waveguide member and said first optical device; and
wherein said second face reflects a second wavelength of light transmitted between said optical waveguide member and said second optical device.

2. The optical module according to claim 1, wherein:
said optical path changing member is a filter;
said first and second faces of said filter are opposing faces;
said filter is disposed such that said first face faces toward said optical waveguide member;
said first face has thereon a film to reflect said first wavelength of light and transmit said second wavelength of light; and
said second face has thereon a film to reflect said second wavelength of light.

3. The optical module according to claim 2, wherein said first and second faces of said filter form different angles with said optical waveguide member.

4. The optical module according to claim 3, wherein:
said angle between said first face and said optical waveguide member is such that said first wavelength of light coupled into said optical waveguide member is reflected by said first face and thereby caused to travel through a center portion of said lens; and
said angle between said second face and said optical waveguide member is such that said second wavelength of light coupled into said optical waveguide member is reflected by said second face and thereby caused to travel through said center portion of said lens.

5. The optical module according to claim 4, wherein one of said first and second optical devices is a light emitting device, and the other is a photodetector.

6. The optical module according to claim 1, wherein:
at least one of said first and second optical devices is a light emitting device;
one of said first and second faces of said optical path changing member partially reflects and partially transmits light emitted from said light emitting device; and
said optical module further comprises a monitor photodetector for receiving light transmitted through said one of said first and second faces.

7. The optical module according to claim 1, wherein said lens is a ball lens.

8. The optical module according to claim 1, wherein said lens is a aspherical lens.

9. The optical module according to claim 1, wherein said second face of said optical path changing member transmits a portion of said second wavelength of light, and wherein said optical module further comprises:
a second lens disposed to receive said portion of said second wavelength of light transmitted through said second face; and
a third optical device disposed to face said optical path changing member through said second lens and optically coupled to said second lens.

10. The optical module according to claim 9, wherein said first and second optical devices are one of light emitting device or photodetector, and the third optical device is the other one of light emitting device or photodetector.

11. The optical module according to claim 9, wherein said second lens is a ball lens.

12. The optical module according to claim 9, wherein said second lens is a aspherical lens.

13. The optical module according to claim 2, further comprising:
a third optical device for transmitting or receiving a third wavelength of light to or from said optical waveguide member through said lens optically coupled to said first and second optical devices, said third wavelength of light being different from said first and second wavelengths of light;
wherein said films on said first and second faces transmit said third wavelength of light;
wherein said second face has thereon a light transmissive layer; and
wherein the side of said light transmissive layer opposite to said second face has thereon a film to reflect said third wavelength of light.

14. The optical module according to claim 1, wherein said first and second optical devices are housed in the same airtight package.

15. The optical module according to claim 1, further comprising an isolator disposed between said optical waveguide member and said optical path changing member.
